(19) United States
(12) Patent Application Publication
(10) Pub. No.: US 2025/0031271 A1
(43) Pub. Date: Jan. 23, 2025

(54) METHOD PERFORMED BY USER EQUIPMENT, AND USER EQUIPMENT

(71) Applicant: SHARP KABUSHHIKI KAISHA, Sakai City, Osaka (JP)

(72) Inventors: Lei LIU, Shanghai (CN); Chongming ZHANG, Shanghai (CN); Renmao LIU, Shanghai (CN)

(21) Appl. No.: 18/716,936

(22) PCT Filed: Dec. 5, 2022
(86) PCT No.: PCT/CN2022/136535

§ 371 Date: Jun. 6, 2024

(30) Foreign Application Priority Data
Dec. 9, 2021 (CN) 202111502581.5

(51) Int. Cl. H04W 76/27; H04W 76/19; H04W 88/04

(52) U.S. Cl. CPC H04W 76/27; H04W 76/19; H04W 88/04

(57) ABSTRACT

Provided in the present invention are a method performed by user equipment, and user equipment. The method includes: receiving, by the UE, an RRC release message transmitted by a network; and in the case that the RRC release message includes a suspend configuration suspendConfig information element, performing, by the UE, the following first action: if the UE is remote UE, entering, by the UE, an RRC inactive state, and performing cell selection or relay selection, or performing cell selection and relay selection.

### TECHNICAL FIELD

The present invention relates to the technical field of wireless communications. More specifically, the present invention relates to a method, performed by user equipment, for remote UE to select relay UE in a sidelink relay architecture, and corresponding user equipment.

### BACKGROUND

At the 3rd Generation Partnership Project (3GPP) RAN #80 plenary meeting in June 2018, the subject of the study on the feasibility of V2X based on 5G NR network technology of Release 16 (see non-patent literature: RP-181480, New SID Proposal: Study on NR V2X) was approved. The primary function included in NR V2X of Release 16 is to support unicast, multicast, and broadcast in out-of-coverage and in-coverage scenarios.

At the RAN #86 plenary meeting in December 2019, a study item on NR sidelink relaying of Release 17 was proposed (see non-patent literature: RP-193253, New Study Item on NR Sidelink Relaying), and was approved. Regarding the latest release of the study item, see non-patent literature: RP-201474, Revised SID: NR Sidelink Relay. The study item mainly studies the solution to user equipment (UE)-to-network and UE-to-UE relaying, so as to extend sidelink-based coverage. The goals of the study item include supporting a sidelink control plane procedure and selection and reselection of relay UE.

At the RAN #91 plenary meeting in March 2020, a work item on NR sidelink relaying of Release 17 was proposed (see non-patent literature: RP-210904, New Study Item on NR Sidelink Relaying), and was approved. Regarding the latest release of the work item, see non-patent literature: RP-212601, Revised WID: NR Sidelink Relay. One of the goals of the work item is to standardize a sidelink control plane procedure, such as management of an RRC connection, reception of a system message, and reception of paging. The goals of the work item further include standardizing a selection and reselection procedure of sidelink relay UE.

Remote UE, in order to perform sidelink communication with a base station or another remote UE, may need to select relay UE to provide a relay service for the remote UE. In a UE-to-base station relay architecture, an RRC connection may be established between remote UE and a base station. When the remote UE selects relay UE to serve the remote UE, the remote UE may also perform relay UE reselection due to various conditions.

The present invention discusses when remote UE initiates selection or reselection of relay UE in a control procedure of an RRC connection procedure performed by the remote UE and a base station, and processing after relay UE is selected or reselected.

### SUMMARY

In order to address at least part of the aforementioned issues, the present invention provides a method performed by user equipment, and user equipment.

A method performed by user equipment (UE) according to a first aspect of the present invention comprises: receiving, by the UE, an RRC release message transmitted by a network; and in the case that the RRC release message comprises a suspend configuration suspendConfig information element, performing, by the UE, the following first action: if the UE is remote UE, entering, by the UE, an RRC inactive state, and performing cell selection or relay selection, or performing cell selection and relay selection.

In the method according to the first aspect of the present invention, in the case that the RRC release message does not comprise the suspendConfig information element, the UE performs the following second action: if the UE is remote UE, entering, by the UE, an RRC idle state, and performing cell selection or relay selection, or performing cell selection and relay selection.

In the method according to the first aspect of the present invention, if the UE is remote UE, the RRC release message is transmitted by the network via relay UE.

In the method according to the first aspect of the present invention, the UE performs the second action only in the case that the RRC release message does not comprise the suspendConfig information element and any one of the following conditions is not satisfied: condition 1: the entering the RRC idle state is triggered by inter-radio access technology (RAT) cell reselection; condition 2: an inter-RAT cell is selected while a timer T311 is running; and condition 3: an evolved universal terrestrial radio access (E-UTRA) cell is selected for EPS fallback for IMS voice.

A method performed by user equipment (UE) according to a second aspect of the present invention, the UE being UE configured by an upper layer to need to search for relay UE, the method comprising: if the UE is out of coverage, or a measured value of reference signal received power (RSRP) of a camped cell of the UE is less than a certain threshold, performing, by the UE, the following actions: if the UE does not have selected relay UE, or if the UE has selected relay UE and a measured value of sidelink reference signal received power (SL-RSRP) or sidelink discovery message reference signal received power (SD-RSRP) of the currently selected relay UE is less than a certain threshold, or if the UE has selected relay UE and a sidelink radio link failure is detected on a PC5-RRC connection between the UE and the current relay UE, evaluating the detected relay UE according to a measurement result of the SD-RSRP, and selecting candidate relay UE therefrom, the SD-RSRP of the selected candidate relay UE being greater than the certain threshold.

In the method according to the second aspect of the present invention, the method further comprises: performing any one of the following actions: •initiating PC5 unicast link establishment; •indicating relay selection or reselection to the upper layer; •indicating the selected candidate relay UE to the upper layer; •establishing a PC5-RRC connection, and indicating the same to the upper layer; and •indicating that the upper layer is required to establish a PC5 unicast link, and/or the method further comprises: in the case that the upper layer has received an indication of any one of the actions, initiating PC5 unicast link establishment.

A method performed by user equipment (UE) according to a third aspect of the present invention, the UE being remote UE, transmitting, by the UE, an RRC re-establishment request RRCReestablishmentRequest message to a network via relay UE, and starting a timer; and in the case that the timer expires or a selected cell becomes a non-suitable cell, performing, by the UE, the following actions: entering, by the UE, an RRC idle state, and performing cell selection or relay selection, or performing cell selection and relay selection.

In the method according to the third aspect of the present invention, the timer stops after the UE receives an RRC re-establishment RRCReestablishment or RRC setup RRCSetup message returned by the network.

In the method according to the third aspect of the present invention, the timer is a T301 timer.

User equipment according to a fourth aspect of the present invention comprises: a processor; and a memory storing instructions, wherein the instructions, when run by the processor, perform the method according to any one of the first aspect, the second aspect, and the third aspect.

### Beneficial Effects of Present Invention

When remote UE enters/returns to RRC_INACTIVE from RRC_CONNECTED or RRC_INACTIVE, and when remote UE enters RRC_IDLE from RRC_INACTIVE or RRC_CONNECTED, the remote UE can promptly trigger processing of relay selection. Furthermore, after relay UE is selected or reselected, the remote UE can establish a PC5 unicast link and a PC5-RRC connection, thereby reducing latency and ensuring quality of service.

### BRIEF DESCRIPTION OF THE DRAWINGS

The above and other features of the present invention will be more apparent from the following detailed description in combination with the accompanying drawings, in which:

FIG. 1 is a schematic diagram showing UE-to-UE relay.

FIG. 2(a), FIG. 2(b), and FIG. 2(c) are schematic diagrams respectively showing scenarios 1, 2, and 3 of UE-to-network relay.

FIG. 3 is a schematic diagram showing a basic procedure of a method performed by user equipment according to Embodiment 1 of the invention.

FIG. 4 is a schematic diagram showing a basic procedure of a method performed by user equipment according to Embodiment 2 of the invention.

FIG. 5 is a schematic diagram showing a basic procedure of a method performed by user equipment according to Embodiment 3 of the invention.

FIG. 6 is a schematic diagram showing a basic procedure of a method performed by user equipment according to Embodiment 4 of the invention.

FIG. 7 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications.
UE: User Equipment
NR: New Radio
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
Sidelink: Sidelink communication
SCI: Sidelink Control Information
AS: Access Stratum
IE: Information Element
CE: Control Element
MIB: Master Information Block
NR: New Radio
SIB: System Information Block
NG-RAN: NG Radio Access Network
DCI: Downlink Control Information
ADAPT: Adaptation layer
PHY: physical layer
RB: radio Bearer
DRB: Data Radio Bearer
SRB: Signaling Radio Bearer
eDRX: Extended DRX
Uu: air interface
ProSe: Proximity based Services
V2X: Vehicle-to-Everything
NAS: Non-Access-Stratum
PC5-S: PC5 signaling
U2N: UE-to-Network
L2: Layer 2
RSRP: Reference Signal Received Power
SL-RSRP: sidelink RSRP, sidelink Reference Signal Received Power
SD-RSRP: sidelink discovery RSRP, sidelink discovery message Reference Signal Received Power
EPS: Evolved Packet System
IMS: IP Multimedia Subsystem
E-UTRA: Evolved Universal Terrestrial Radio Access

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type. Remote UE may refer to UE connected to the network via U2N relay UE, or may refer to UE having capabilities of NR sidelink U2N remote UE. The relay UE may refer to UE that supports providing a connection to the network for remote UE, or UE having the foregoing capability. “Relay UE” and “NR sidelink U2N Relay UE” are interchangeable.

In the present invention, sidelink and PC5 are interchangeable. “Feedback”, “report”, “reporting”, “transmission”, and “notification” are interchangeable. “Activation”, “employing”, “application”, “enabling”, “activating”, “implementation”, etc., are interchangeable.

In the present invention, relay selection may only mean that remote UE selects relay UE when not connected to a base station via relay UE, or may mean that remote UE selects relay UE when not connected to a base station via relay UE and that remote UE reselects relay UE when the remote UE is already connected to a base station via relay UE (i.e., relay reselection).

In the present invention, an upper layer may refer to a ProSe layer, or a V2X layer, or a NAS layer, or a PCS-S protocol layer.

In the present invention, PC5-S link and PC5 unicast link are interchangeable. ProSe layer, V2X layer, NAS layer, and PC5-S protocol layer are interchangeable.

It should be noted that in the present specification, two items that are connected by “and”, “or”, or “and/or” may indicate different expression methods for the same intent in different application scenarios. It is possible that a relationship of including or being included in is present between the two items, but it is not necessary that the two items refer to completely different content.

Hereinafter, a description will be given of related art of the present invention.

A PC5 interface is an interface for performing control plane and user plane sidelink communication between UE and UE. For sidelink unicast, a PC5-RRC connection is an AS layer logical connection between a pair of a source layer-2 ID and a target layer-2 ID. Establishment of one PC5 unicast link corresponds to establishment of one PC5-RRC connection.

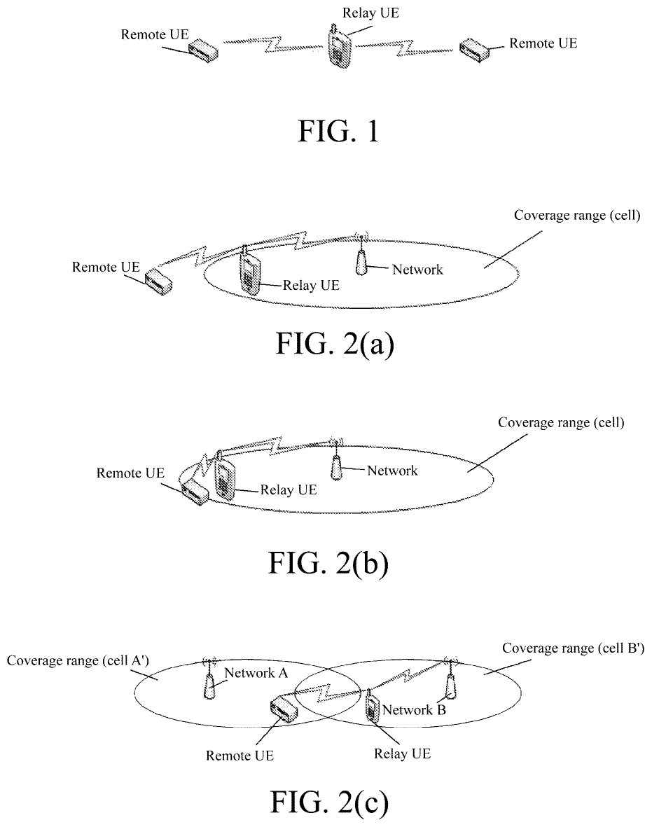

UE-to-UE relaying is as shown in FIG. 1. The left and the right are remote UEs, and the middle is relay UE. The remote UEs are respectively connected to the relay UE by means of PC5 interfaces. Because the two pieces of remote UE are far from each other or because a communication environment is poor, the relay UE is needed to relay and forward signaling and data therebetween.

UE-to-UE relay scenarios include:
1) in coverage: the two pieces of remote UE (i.e., the source-side UE and the target-side UE) and the relay UE are all in coverage;
2) out of coverage: the two pieces of remote UE (i.e., the source-side UE and the target-side UE) and the relay UE are all out of coverage; and
3) partial coverage: among the two pieces of remote UE and the relay UE, at least one piece of UE is in coverage, and at least one piece of UE is out of coverage.

UE-to-network relaying is as shown in FIGS. 2(a), (b), and (c). In scenario 1 and scenario 2 in FIGS. 2(a) and (b), the left side is remote UE, the middle is relay UE, and the right side is a network. In scenario 3 in FIG. 2(c), both sides are networks (e.g., networks A and B), and the middle, from left to right, is remote UE and relay UE, respectively. The remote UE and the relay UE are connected to each other via a PC5 interface, and the relay UE is connected to the network via a Uu interface. Because the remote UE is far from the network or because the communication environment is poor, the relay UE is needed to relay and forward signaling and data between the remote UE and the network.

UE-to-network relay scenarios include:
1) the remote UE is out of coverage, and the relay UE is in coverage;
2) the remote UE and the relay UE are both in coverage, and are in the same cell; and
3) the remote UE and the relay UE are both in coverage, but are in different cells (e.g., cells A′ and B′).

### Uu RRC Connection and State

A reference point between UE and a radio access network is referred to as Uu, so that a connection between the UE and the radio access network is referred to as a Uu connection. In a Uu connection, depending on the state of a Uu RRC connection, the state of UE can be an idle state (RRC_IDLE state), an inactive state (RRC_INACTIVE state), or a connected state (RRC_CONNECTED state). After an RRC connection is established, the UE may be in the RRC_INACTIVE or RRC_CONNECTED state. If no RRC connection is established, the UE is in the RRC_IDLE state.

After an RRC connection is established between the remote UE and a radio access network, the remote UE may be in the RRC_INACTIVE or RRC_CONNECTED state, and if no RRC connection is established, the UE is in the RRC_IDLE state. Similarly, the relay UE may also be in one of these three states. Upon receiving an RRCRelease message transmitted by the network and carrying suspendConfig (a suspend configuration), the remote UE in the RRC_CONNECTED or RRC_INACTIVE state enters or returns to the RRC_INACTIVE state. Upon receiving an RRCRelease message transmitted by the network and carrying no suspendConfig, the remote UE in the RRC_CONNECTED or RRC_INACTIVE state enters the RRC_IDLE state.

It should be noted that when the remote UE is in RRC_CONNECTED, the relay UE must be in RRC_CONNECTED, and when the remote UE is in RRC_INACTIVE/RRC_IDLE, the relay UE may be in any one of the three states, i.e., RRC_CONNECTED/RRC_INACTIVE/RRC_IDLE.

After the remote UE selects relay UE to provide a relay service for the remote UE, since there is data in an application layer that needs to be transmitted, the application layer triggers a procedure of the ProSe layer establishing a PC5 unicast link (between the remote UE and the relay UE). After the PC5 unicast link is established, the ProSe layer instructs an AS layer, and the AS layer establishes a PC5-RRC connection as required by the ProSe layer, so as to communicate with the network via the relay UE. For the NR sidelink L2 U2N relay architecture, procedures such as RRC connection establishment, release, re-establishment, and resumption, may be present between the remote UE and the network. The remote UE can establish an air interface RRC connection to the network via the relay UE for data transmission between the remote UE and the network. The remote UE encapsulates messages of procedures such as RRC connection establishment, re-establishment, and resumption, to the network in a PC5 message and transmits the PC5 message to the relay UE, and the relay UE forwards the PC5 message to the network after receiving the PC5 message. Conversely, an RRC message returned by the network is encapsulated in a PC5 message by the relay UE and forwarded to the remote UE. The remote UE can acquire a system message of a cell via the relay UE. The remote UE can also receive a paging message of the network via the relay UE.

After the remote UE establishes a connection to the network and enters RRC_CONNECTED, relay selection and/or reselection is stopped. However, the remote UE may trigger relay selection and/or relay reselection according to various reasons such as a PC5 link measurement result, or an indication from the upper layer, or an indication from relay UE.

After the remote UE selects or reselects relay UE, it is possible that a system message or a paging message of the network side needs to be received or other RRC-specific signaling needs to be transmitted/received. However, in this case, the application layer is not aware of such requirements, so establishment of a PC5 unicast link and a PC5-RRC connection cannot be initiated, and therefore, the system message and paging cannot be acquired, or the RRC-specific signaling cannot be transmitted/received.

A typical scenario discussed in the present invention is: when remote UE enters/returns to RRC_INACTIVE from RRC_CONNECTED or RRC_INACTIVE, and when remote UE enters RRC_IDLE from RRC_INACTIVE or RRC_CONNECTED, how the remote UE in RRC_INACTIVE or RRC_CONNECTED promptly triggers processing of relay selection; and after relay UE is selected or reselected, how the remote UE establishes a PC5 unicast link and a PC5-RRC connection, thereby reducing latency and ensuring quality of service.

Hereinafter, several embodiments of the present invention for addressing the above problems are described in detail.

### Embodiment 1

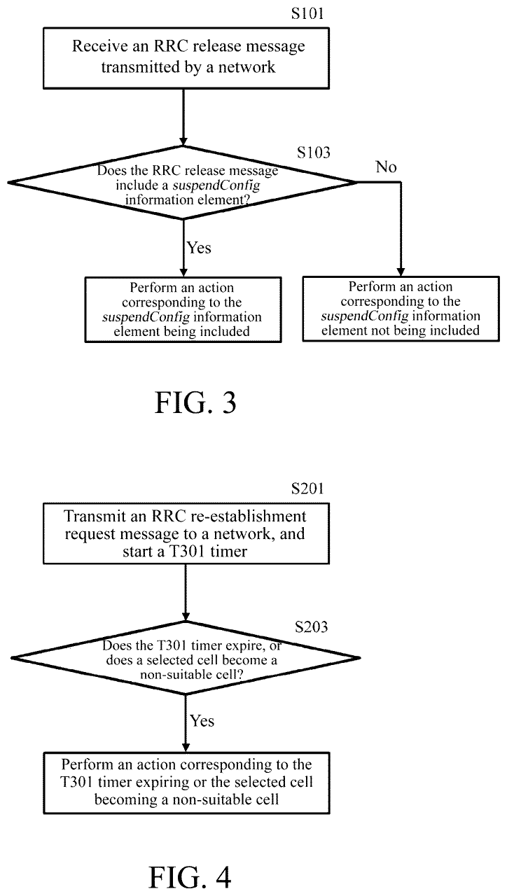

As shown in FIG. 3, the present embodiment includes steps 101 and 103.

Optionally, in step 101, receiving, by UE, an RRCRelease message transmitted by a network.

For remote UE, the RRCRelease message transmitted by the network is forwarded via relay UE.

Optionally, in step 103, if the RRCRelease message includes a suspendConfig (suspend configuration) information element, performing, by the UE, the following determination and actions:
If the UE is connected to L2 U2N relay UE via a PC5-RRC connection, that is, the UE is remote UE, the UE enters RRC_INACTIVE, and performs cell selection or relay selection, or performs cell selection and relay selection.
Otherwise, the UE enters RRC_INACTIVE, and performs cell selection.

If the RRCRelease message does not include the suspendConfig information element, the UE performs the following actions:
If the UE is connected to L2 U2N relay UE via a PC5-RRC connection, that is, the UE is remote UE, the UE enters RRC_IDLE, and performs cell selection or relay selection, or performs cell selection and relay selection.
Otherwise, the UE enters RRC_IDLE, and performs cell selection.

Optionally, if the RRCRelease message does not include the suspendConfig information element, a determination may further be added, and the UE performs the above-described actions only in the case that any one of the following conditions is not satisfied:
entering RRC_IDLE is triggered by inter-radio access technology (RAT) cell reselection;
an inter-RAT cell is selected while T311 is running; and
an E-UTRA cell is selected for EPS fallback for IMS voice.

### Embodiment 2

As shown in FIG. 4, the present embodiment includes steps 201 and 203.

Optionally, in step 201, initiating, by UE, an RRC connection reestablishment procedure, transmitting an RR (ReestablishmentRequest message to a network, and starting a T301 timer. T301 stops after remote UE receives an RR (Reestablishment or RRCSetup message returned by the network.

Optionally, in step 203, if the T301 timer expires or a selected cell becomes a non-suitable cell, performing, by the remote UE, the following actions:
If the UE is connected to L2 U2N relay UE via a PC5-RRC connection, that is, the UE is remote UE, the UE enters RRC_IDLE, and performs cell selection or relay selection, or performs cell selection and relay selection.
Otherwise, the UE enters RRC_IDLE, and performs cell selection.

### Embodiment 3

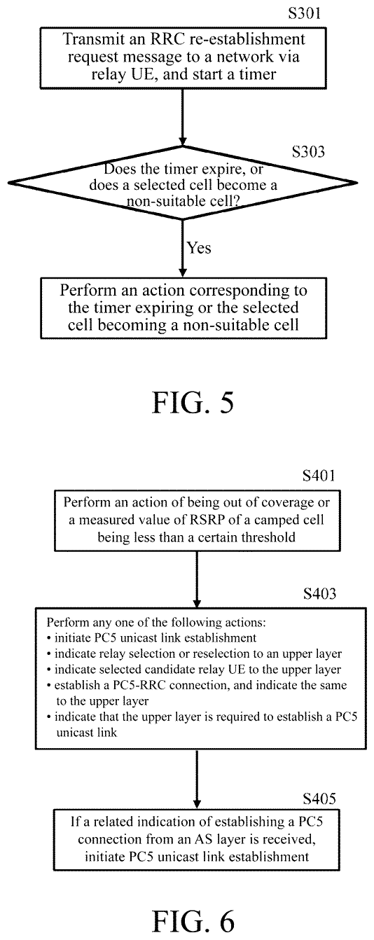

As shown in FIG. 5, the present embodiment includes steps 301 and 303.

Optionally, in step 301, initiating, by remote UE, an RRC connection reestablishment procedure, transmitting an RRCReestablishmentRequest message to a network via relay UE, and starting a timer. The timer stops after the remote UE receives an RRCReestablishment or RRCSetup message returned by the network.

Optionally, in step 303, if the timer expires or a selected cell becomes a non-suitable cell, entering, by the remote UE, RRC_IDLE, and performing cell selection or relay selection, or performing cell selection and relay selection.

It should be noted that in Embodiment 1, Embodiment 2, and Embodiment 3, “performing cell selection or relay selection” means that either one of the cell selection and the relay selection is performed. “Performing cell selection and relay selection” means that both the cell selection and the relay selection are performed.

### Embodiment 4

As shown in FIG. 6, the present embodiment includes steps 401, 403, and 405.

Optionally, in step 401, if UE configured by an upper layer to need to search for relay UE is out of coverage, or a measured value of RSRP of a camped cell of the UE is less than a certain threshold, performing the following determinations and actions:
if the UE does not have selected relay UE, or if the UE has selected relay UE and a measured value of SL-RSRP or SD-RSRP of the currently selected relay UE is less than a certain threshold, or if the UE has selected relay UE and a sidelink radio link failure is detected on a PC5-RRC connection between the UE and the current relay UE, evaluating detected relay UE according to a measurement result of the SD-RSRP, and selecting candidate relay UE therefrom, the SD-RSRP of the selected candidate relay UE being greater than the certain threshold.

Optionally, in step 403, the UE may perform any one of the following operations:
initiating a PC5 unicast link establishment procedure;
indicating relay selection or reselection to the upper layer;
indicating the selected candidate relay UE to the upper layer;
establishing a PC5-RRC connection, and indicating the same to the upper layer; and
indicating that the upper layer is required to establish a PC5 unicast link.

It should be noted that, in the above description, thresholds compared with the measured value of the RSRP of the camped cell of the UE, the measured value of the SL-RSRP or the SD-RSRP of the currently selected relay UE, and the measured value of the SD-RSRP of the selected candidate relay UE may be different parameters configured by the network, or may be pre-configured parameters, and the values of the parameters may be the same or different.

Optionally, in step 405, if the upper layer receives a relay selection or reselection indication indicated by an AS layer, or receives selected candidate relay UE indicated by the AS layer, or receives a PC5-RRC setup indication indicated by the AS layer, or receives an indication that a PC5 unicast link is required to be established, initiating a PC5 unicast link establishment procedure.

Optionally, in another example of step 405, if the remote UE has selected or reselected relay UE, a ProSe layer of the remote UE initiates a PC5 unicast link establishment procedure, or otherwise, the ProSe layer establishes a PC5 unicast link as required by the upper layer (e.g., an application layer). In the present example, L2 U2N relay UE finally selected or reselected by the remote UE may be determined by the ProSe layer, or may be determined by the AS layer (e.g., an RRC layer). Optionally, after the remote UE selects or reselects relay UE, the remote UE may further determine that a PC5 unicast link establishment procedure is initiated only when the selected relay UE is L2 U2N relay UE.

Optionally, in another example of step 405, if the remote UE receives a discovery message of the relay UE, and selects the relay UE to serve the remote UE, a PC5 unicast link establishment procedure is initiated. Optionally, the remote UE may further determine that a PC5 unicast link establishment procedure is initiated only when the selected relay UE is L2 U2N relay UE.

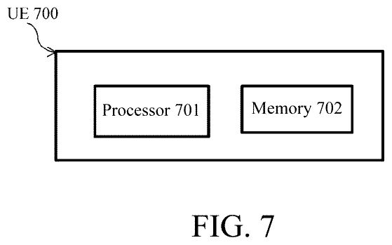

FIG. 7 is a simplified structural block diagram of user equipment (UE) according to the present invention. As shown in FIG. 7, user equipment (UE) 700 includes a processor 701 and a memory 702. The processor 701 may include, for example, a microprocessor, a microcontroller, an embedded processor, and the like. The memory 702 may include, for example, a volatile memory (such as a random access memory (RAM)), a hard disk drive (HDD), a non-volatile memory (such as a flash memory), or other memories, etc. The memory 702 has program instructions stored thereon. The instructions, when run by the processor 701, can perform the above method performed by user equipment described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A User Equipment (UE), comprising a processor configured to:
in a case that the UE receives an RRCRelease message with a suspend configuration, wherein the UE is capable of a UE-to-Network (U2N) remote UE,
enter an RRC_INACTIVE state, and
perform either or both of cell selection and relay selection.

12. A User Equipment (UE), comprising a processor configured to:
in a case that the UE receives an RRCRelease message without a suspend configuration, wherein the UE is capable of a UE-to-Network (U2N) remote UE,
enter an RRC_IDLE state, and
perform either or both of cell selection and relay selection.

13. A method performed by a User Equipment (UE), the method comprising:
in a case that the UE receives an RRCRelease message with a suspend configuration, wherein the UE is capable of a UE-to-Network (U2N) remote UE,
entering an RRC_INACTIVE state, and
performing either or both of cell selection and relay selection.
